(19) United States
(12) Patent Application Publication
(10) Pub. No.: US 2009/0150295 A1
(43) Pub. Date: Jun. 11, 2009

(54) VALIDATION SERVICE FOR PAYMENT CARDS WITH PRELOADED DYNAMIC CARD VERIFICATION VALUES

(76) Inventors: Jeffrey Alan Hatch, Pleasanton, CA (US); Durga Ramana Muktevi, Fremont, CA (US)

Correspondence Address: RICHARD B. MAIN, ESQ.;PATENTS PENDING, 9832 LOIS STILTNER CT., ELK GROVE, CA, 95624, US

(21) Appl. No.: 11/953,066

(22) Filed: Dec. 9, 2007

(51) Int. Cl. H04L 9/32

(52) U.S. Cl. 705/71; 705/76

(57) ABSTRACT

QSecure Validation Service (QVS™) is part of the QSecure Suite and includes a CVQ Table Generator (QTG) for use with a QBox™ card personalizer. In general, the QVS/QVM compares dynamic CVQ token data fetched by an issuer authorization host from a transaction then occurring in the field. An array of acceptable CVQ values computed in real-time from the original keys and algorithms used by the QTG and QBox to personalize the particular card are applied in the comparison. There is an order to the CVQ values in such array, and the dynamic CVQ token data will step through these over time. Small deviations in the order actually received can normally occur for reasons other than fraud, so a moving window of acceptance is needed to cope with normal deviations. A running account of which CVQ values have already been used is maintained for, or by, the QVS, and these help predict where the acceptance window should next be positioned in the array of acceptable CVQ values.

### BACKGROUND OF THE INVENTION

1. Field of the Invention

The present invention relates to payment card financial transaction systems. In particular, the present invention relates to back-end services for financial transaction payment processors to help validate the use-once card verification values they elicit from payment cards. Such cards are able to issue a new card verification value from stored tables for each new transaction during their respective service lives.

2. Description of Related Art

Card verification values (CVV or CVC) are a security feature used on credit, debit, and other payment cards to improve protection from credit card fraud. A first type of conventional CVV (CVV1) was encoded on the magnetic stripe on the rear of the card and was only useful for card-present transactions. Such as with a magnetic card reader at a point-of-sale terminal. A second type of conventional CVV (CVV2) came along to help secure card-not-present transactions, such as by Internet or over the phone. Most people are now familiar with the three or four digits printed on the payment card that must be read to complete a transaction on the phone or over the Internet. Amex cards use four-digits on the front, and others use three-digits on the reverse near the signature panel.

CVV digits that don't change and that are always associated with particular account numbers are not very secure. A fraudster has only to record the CVV value and the personal account number together to continue making fraudulent transactions, such as from a simple copy of a legitimate transaction.

### SUMMARY OF THE INVENTION

Briefly, an application software embodiment of the present invention includes installation scripts for self-installation on a platform host or appliance located in a card issuer's secure payment processing center. The identifiers for the encryption algorithms that were used to generate and load electronic tables of CVQ values during the personalization of a population of payment cards are stored. During each financial transaction request later initiated by a point-of-sale terminal and a payment card, the next new CVQ is elicited and presented for validation. The application software uses the payment card account number to index from the secure storage the particular key and algorithm used to encrypt CVQ values for the respective payment card. An array of these encrypted CVQ values is generated and used to check against the CVQ value being presented for validation. If valid, a further check is made to see if the presented CVQ value has been used before, and whether it's in the neighborhood of values that have been most recently used. If too far out of the range of CVQ values currently expected to be used, then fraud can be the culprit. A score is returned by the host or appliance to be evaluated by the payment processing host and used in a decision to authorize the requested transaction.

An advantage of the present invention is that a system is provided that improves payment card security against fraud.

Another advantage of the present invention is that a method is provided for detecting where and when attempts at fraud have occurred.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1 is a functional block diagram of system embodiment of the present invention for detecting fraud in payment card transactions;

FIG. 2 is a flowchart diagram of a method embodiment of the present invention for detecting fraud in payment card transactions;

FIG. 3 is a functional block diagram of a QSecure Suite showing how QVS/QVM, QTG, and QBox embodiments of the present invention interconnect and function in a payment card system and card issuer data center; and

FIG. 4 is a dataflow diagram showing how a provided CVQ value is compared with a CVQ list and scored according to used/new, OK replay, OK discontinuous, etc.

### DETAILED DESCRIPTION OF THE INVENTION

QSecure, Inc. (Los Altos, Calif.) payment cards issue new, use-once CVQ values for every transaction. A next new CVQ is recorded to the magnetic stripe using QSecure SmartStripe technology, and/or a next new CVQ is presented on a display for the user to read. Each new CVQ value is elicited from an electronic table of values that was downloaded to a QSecure payment card core during personalization by the card issuer. The next new correct value is not predictable from any of the previous CVQ values because of encryption. Encryption keys and algorithms known only to the card issuer are used to generate such electronic tables of values, and the issuer can therefore validate each CVQ as they are presented later during the service life of each particular payment card.

Herein, “CVV” is used in the most generic sense to include conventional “CVV1” and “CVV2” values. These are separate and distinct from QSecure's proprietary dynamic security data token “CVQ”, which is added, e.g., to the discretionary data in Track-2 of the payment card's magnetic stripe. So the CVQ does not physically replace any CVV, thus allowing normal card processing in the traditional way when the machinery involved cannot, or choose not to support CVQ validation.

In current embodiments of QSecure payment cards, a five digit CVQ is implemented with a magnetic device in a so-called VANcard SmartStripe, and with an LCD display in a so-called PANcard. The details of these payment card implementations are described in several other United States patents and patent applications assigned to QSecure, Inc. (Los Altos, Calif.), and especially those listing Kerry D. Brown as an inventor. Such are incorporated herein by reference.

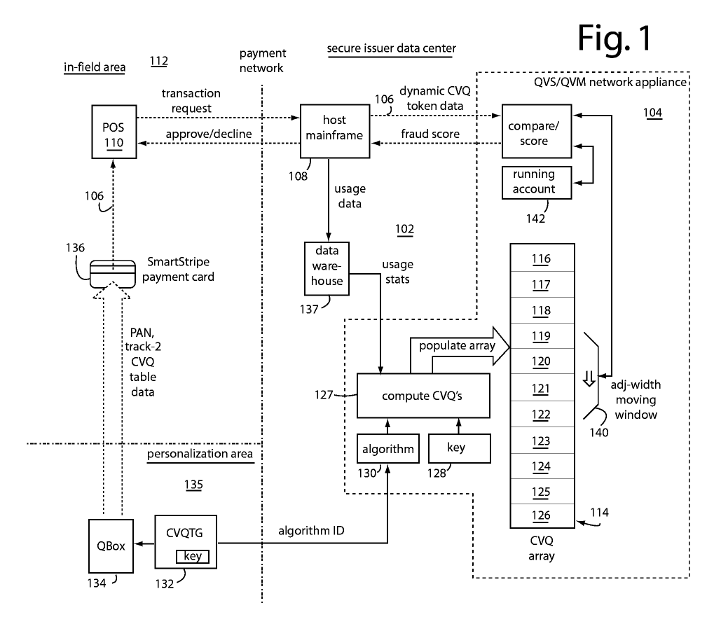

FIG. 1 represents a system embodiment of the present invention for detecting fraud in payment card transactions, and is referred to herein by the general reference numeral 100. Such system 100 is intended to be installed by a payment card issuer in their secure financial transaction authorization host environment, e.g., in a small platform attached to a mainframe or server. A computer application program is deliverable on a disc or as a download for a subscription fee and is accompanied by scripts that permit automated installation.

Once installed in a secure financial transaction authorization host environment 102, a QSecure validation module (QVM) or service (QVS) 104 compares dynamic card verification value (CVQ) token data 106 fetched by an issuer authorization host 108 from a transaction initiated by a point-of-sale (POS) device 110 then occurring in the field 112. An array 114 of acceptable CVQ values, e.g., 116-126, computed in real-time by a processor 127 from the original keys 128 and encryption algorithms 130 are applied in the comparison. A copy of the original keys 128 are made available to the QVS, e.g., though an HSM. A pointer provided indexes encryption algorithms 130 that were used by a QTG 132 and QBox 134 to personalize the particular card 136. The QTG 132 is privately provided a key, e.g., through a hardware connection to an HSM. That way the keys are never transmitted as data through any part of the system nor are they ever stored outside the secured confines of an HSM. A data warehouse or other storage 137 collects card usage data and provides usage statistics.

The acceptable CVQ values 116-126 are not kept nor stored longer than they are needed to help validate a present financial transaction. In subsequent financial transactions in the future, the acceptable CVQ values 116-126 are computed anew. Long-term storage of CVQ values is considered an unnecessary security risk.

In some embodiments of the present invention, there is an order to the CVQ values 116-126. Card 136 will percolate each CVQ value assigned to it and use them once, for example, beginning with CVQ value 116 and ending with 126. Alternatively, each CVQ used could be associated with an index number, e.g., to make recognizing the sequence step easier. A two-year supply of unique numbers is typical, so given average use, e.g., three thousand unique CVQ values are loaded into each payment card as they are issued. Later when the payment card is being presented in a financial transaction, the CVQ values that would be valid for the particular card are recomputed as needed in real-time at the issuer data center. They are cached temporarily in array 114 for comparison tests.

The dynamic CVQ token data 106 from each particular card 136 can be expected to step through its assigned CVQ values more or less in some kind of predictable order over time. So legitimate CVQ values will cluster at points in time in expected ways. Small deviations in the order of CVQ values actually received for validation from the host can occur for reasons other than fraud. So a moving acceptance window 140 with an adjustable width is used in one embodiment. Such is used to cope with the steps made over time and the normal deviations in the order of the CVQ values that will be received for validation. A running account 142 of which CVQ values 116-126 have already been used is maintained for, or by, the QVS/QVM 104, and these help predict where acceptance window 140 should next be positioned in the array of acceptable CVQ values. Card usage behavior can also be factored into such window to improve fraud detection.

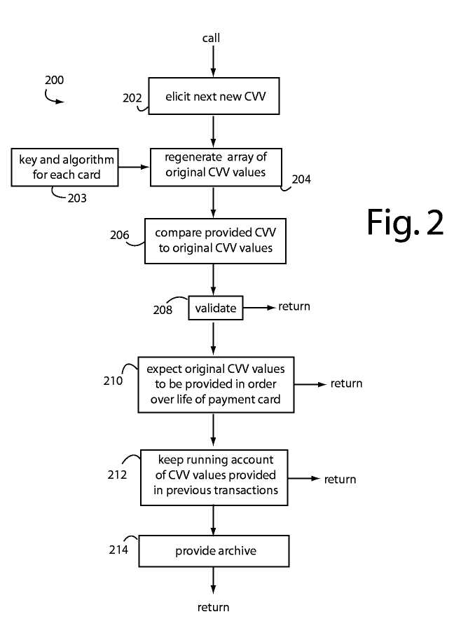

FIG. 2 represents a method embodiment of the present invention for validating payment card transactions, and is referred to herein by the general reference numeral 200. Method 200 is called after eliciting a card verification value from a payment card contemporaneously involved in a financial transaction, in a step 202. Such card verification value is one of many that are electronically programmed into such payment cards when they were earlier personalized and issued to users. A step 203 provides the key and algorithm identifiers to allow recompilation of the original card verification values. In a step 204, an array of card verification values is regenerated from a key and an encryption algorithm that were used originally to personalize the particular the payment card. The card verification value obtained in the step of eliciting is compared, in a step 206, to the individual card verification values included in the array obtained in the step of regenerating. The financial transaction is validated, in a step 208, based on the results obtained in step 206. Method 200 can return at this point to the calling program.

Otherwise, method 200 can further comprise expecting card verification values elicited from particular payment cards to follow an order of use, as in a step 210. Certain card verification values can be expected to be used soon and others can be expected not to be used for some time if fraud is not a factor. A step 212 keeps a running account of which card verification values elicited from particular payment cards have been used and when. Such will enable a prediction of which card verification values can be expected to be used soon and which others can be expected not to be used for some time if fraud is not a factor.

An archive of such information, in a step 214, may be collected in real-time to validate financial transactions later that seem to originate from the payment card.

A computer program embodiment of the present invention for validating payment card transactions is based on method 200. It comprises a service module for receiving a CVQ from a payment card contemporaneously involved in a financial transaction. A second service module builds an array of card verification values from a key and an encryption algorithm that were used originally to personalize the particular the payment card. A third service module inspects the card verification value obtained in the step of eliciting against individual card verification values included in the array. A fourth service module can validate the financial transaction.

Another service module looks for the card verification values from particular payment cards to follow an order of use, wherein certain card verification values can be expected to be used soon and others can be expected not to be used for some time if fraud is not a factor. A further service module stores a running account of the card verification values already used by particular payment cards and when, for a prediction of which card verification values can be expected to be used soon and others can be expected not to be used for some time if fraud is not a factor. A fifth service module stores information that identifies the keys and encryption algorithms originally used to electronically program the payment card when it was personalized and issued to the user. A sixth service module controls an archive of such information as needed in real-time later to validate financial transactions that seem to originate from the payment card.

One task of CVQ validation during payment authorization is to compare an event-sensitive CVQ value included in the authorization message with a table of acceptable values associated with the personal account number (PAN) in a QVS/QVM or QVM database table storing card specific attributes.

QTG 132 (FIG. 1) calls for a calculation of the initial table of CVQ values for a given card 136 that were downloaded in by QBox 134 during the personalization process. Such personalization is done at card issuance time, by an issuer, a personalization bureau, or an intermediary. The table is included or added to a corresponding QBox file, and process that is provided to the service bureau who is encoding the magstripe for that particular card. The generation of the tables is flexible enough to allow issuers to change keys easily and can generate large numbers of tables each associated with particular accounts, e.g., 50,000 tables a day.

If storage space is available, and security concerns are addressed, tables of the original CVQ values can be maintained for every active card and need not be recomputed for transaction validations.

CVQ Table Generation is very different than prior art CVQ/CVQ number generation where only one value per payment card is needed and never changes. QTG 132 off-loads CVQ table generation from the host mainframe 108, and thus simplifies the installation of QVM and QVS/QVM 104 into preexisting secure environments. The re-generation of the table originally loaded into the card allows the QVS/QVM 104 to make validation scores. Encryption key control can be maintained within the card issuer facility.

CVQ table generator 132 and QBox 134 embodiments of the present invention have the advantage of helping increase commercial sales and the rapid adoption of products like the QVS/QVM 104. Generating tabular data and programming hardware for the personalization of each payment card is required when such cards use QSecure SmartStripe technology or other means to communicate dynamic CVQ tokens.

A software utility is provided with QTG 132 for card personalization that creates unique CVQ table values for each payment card 136. Such avoids having to share the encryption keys with outsiders and intermediaries. Each card issuer maintains their own key control. Table generation and programming can be decoupled from the rest of the personalization process, and that helps to further assure the security of the issuer's algorithms and keys.

Briefly, each QTG 132 will typically include, e.g., a browser-based graphical user interface (GUI) for administrative access, and user and encryption configuration setting management. Administration includes saving settings to link to supported hardware encryption devices. CVQ tables may be generated for card lists by run or batch. The encryption algorithms to be used are identified for each run, and are typically selected from a list.

Cards can be uniquely identified by their personal account number (PAN) and sequence number. Such can be used in audit logs as a unique context identifier. For PAN Cards, the PAN is a concatenation of fixed and variable parts, the variable part being a dynamic token. A separate and unique account number provides each card record in the input files with redistribution of PAN-field data, CVQ generated data, expiration data, and possible coupling to the discretionary data field correlation functions, etc. In an alternative embodiment of a PANcard, the CVQ can substitute for the CVV2 in card-not-present transactions.

CVQ table data is needed by card personalization bureau systems to record the magnetic stripe data, and to initialize the internal electronics, e.g., using non-volatile RAM and/or programmable fuse links. The QBox 134 is a recipient of the CVQ table data generated from each run. The QBox 134 permanently loads firmware into a microcontroller and records the CVQ information onto the SmartStripe payment cards 136.

During the routine processing of each dynamic CVQ token or SmartStripe-enabled financial transaction, the CVQ token data must be sent with the transaction request to the issuer host 108 and be validated against a list of acceptable values associated with that card, e.g., array 114. Each QVS/QVM instance for a given bank must access to a corresponding CVQ table for each card it might see in a transaction, e.g., via XML messages.

The system provides a facility to set and save the selection of the desired cryptographic algorithm, either from a list of predefined values, or the custom algorithm. This setting is saved and remain in place from one system session to the next and is customer defined or selected. Key generation is customer-centric, and the QBox must conform to customer interface standards.

QTG 132 allows the selection of predefined encryption algorithms from a list. These can be used for batch runs soon after. QTG 132 also allows linkage to customer-provided cryptography algorithms. Such linkage can be a call to a software module (e.g. JAR for java), the class path to it provided, and its interface must match.

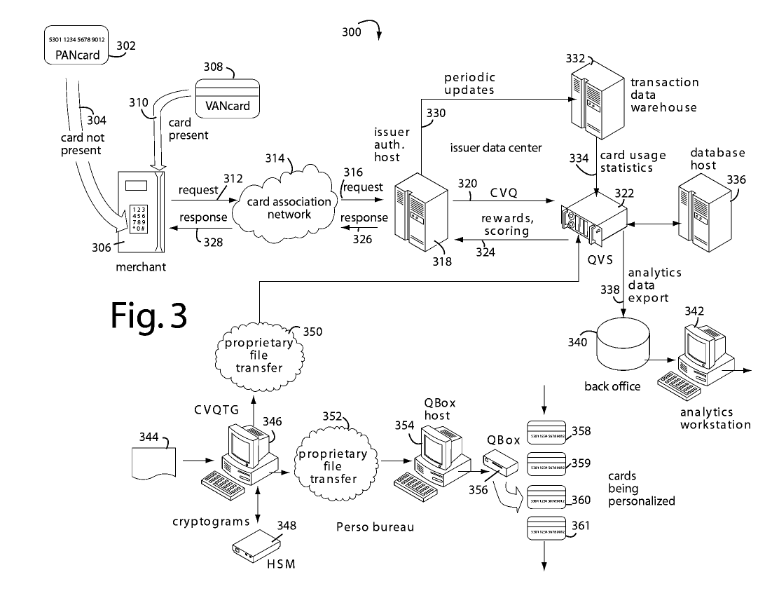

FIG. 3 represents a QSecure Suite 300 and shows how QVS/QVM, QTG, and QBox embodiments of the present invention interconnect and function in a payment card system and card issuer data center. The QSecure Suite 300 typically operates in an environment where a PANcard type payment card 302 provides a visual display of a dynamic CVQ token data in a card-not-present read 304 into a merchant point-of-sale (POS) terminal 306, or a VANcard type payment card 308 provides a magnetic encoding through a SmartStripe of a dynamic CVQ token data in a card-present read 310 into POS terminal 306. A transaction request 312 includes the transaction ID, personal account number (PAN), sequence number, merchant category code, and the CVQ. A card association network 314, e.g., VISA, MasterCard, AMEX, etc., translates this into a card issuer request 316 for an issuer authorization host 318 in an issuer data center. A CVQ part 320 of the request for authorization and ancillary data is passed to a QSecure validation service (QVS) or QSecure validation module (QVM) 322 over a network connection.

A typical issuer authorization host will comprise an IBM mainframe, server, or other computer with software coded in Java, C, Cobol or C++. The physical link will typically be a TCP/IP connection, with message passing carried by IBM Websphere MQ or Web Services. WebSphere ESB can be used for message I/O and translation from Cobol CopyBook format to XML, a normalized input format that is preferably used by the QVS/QVM.

The QVS/QVM 322 will analyze the CVQ provided and return an analysis code or score 324. For example, the score can indicate the CVQ is suspect or not, used or new, an acceptable replay of a recently used value, or a non-contiguous value that is not too far off from what was expected. The QVS/QVM 322 can also return a rewards loyalty program message or counter to be used in an incentives program.

The issuer authorization host 318 can incorporate analysis code or score 324 into its decision whether to authorize the financial transaction requested. Such will do this in two steps. The first are the anti-fraud measures that test the incoming request 316 for valid account numbers and CVV or CVV2 values and expiry. The second step does the accounting, e.g., to see if there is enough headroom in the user's available balance to cover the dollar amount requested, and then to place a hold on those funds for reconciliation later.

A card issuer response 326 either approves or declines the transaction. This is relayed to the appropriate POS 306 by card association network 314.

Periodic updates 330 of card activity are summarized in a transaction storage 332. Card usage statistics 334 are available to QVS/QVM 322. A database host 336 stores CVQ values that have already been used. An analytics data export 338 is sent to a back office database 340 for use by an analytics, statistics workstation 342.

All the payment card data needed to personalize a payment card, less the CVQ tables for each card, are provided in a file 344 to a CVQ table generator (QTG) workstation 346. A hardware security module (HSM) 348 is used for high speed computing of CVQ table values given the keys and algorithms dictated in input file 344. A proprietary file transfer 350 provides these algorithms to QVS/QVM 322, and such can be stored in database host 336. At a personalization bureau, another proprietary file transfer 352 provides the data needed to personalize a batch run of new payment cards. A QBox host 354 allows an operator to set up the batch run and initialize a QBox 356. A run of cards 358-361, for example, are then programmed with the CVQ tables and other data, such as the magnetic stripe account numbers.

As a commercial product, the QVS/QVM can be packaged to include a CVQ Table Generator (QTG) for use with a QBox™. The QTG can also be sold separately under license for the QVS methods. In general, the QVS/QVM compares dynamic CVQ token data fetched by an issuer authorization host from a transaction then occurring in the field. An array of acceptable CVQ values computed in real-time from the original keys and algorithms used to personalize the particular card are used in the comparison. There is an order to the CVQ values in such array, and the dynamic CVQ token data will step through these over time. Small deviations in the order actually received can normally occur for reasons other than fraud, so a moving window of acceptance is needed to cope with normal deviations. A running account of which CVQ values have already been used is maintained for, or by, the QVS, and these help predict where the acceptance window should next be positioned in the array of CVQ values.

Routine transaction authorization requests are sent from a merchant point-of-sale (POS) device through a payment network to an issuer host. Such host puts together a package including the transaction ID, transaction date/time, and some of the card's track-2 data that it forwards to the QVS. The QVS/QVM analyzes the data it receives, and returns what amounts to an acceptance score. E.g., how well the information fit to what was expected, and given the moving acceptance window. The QVS/QVM adjust the window center and width based on previous transaction activity history seen by the QVS, and other information provided by the issuer's storage. A fraud analysis is returned to the issuer authorization host, and the particulars can result in denying the authorization. At least four classifications for scores can be used, e.g., the CVQ was already used and is too old, the CVQ was used recently, the CVQ is not yet used and is expected to be used soon, and the CVQ is being presented far too early. Of course, if the CVQ value received isn't even a legitimate one given the key and algorithm associated with the card, then the transaction requested is obviously fraudulent.

As each new SmartStripe card enters circulation, the QVS/QVM is provided with the issue date and an identification of the particular algorithm used to personalize the card. The QTG may be located either in the personalization bureau, or at the issuer, and is used to generate a table of CVQ values for each card. These are then forwarded to a corresponding QBox controller for card personalization.

Credit card issuers tend to view the CVQ with the same sensitivity as a CVV and as such the same security precautions are relevant. This concern means that the CVQ values may not be stored. When a QVS/QVM receives the transaction track data, the CVQ validation must compare the provided CVQ against all the possible CVQ values for a given card. Such can be stored or calculated on-the-fly using the same cryptography algorithm originally used on that card by QTG.

Embodiments of the present invention can be licensed, e.g., an upfront license cost or a usage-based cost tied to the number of QSecure cards in use by an issuer. Such license costs include an annual support component. Installation is implemented by a set of installation scripts that would copy the relevant application files into their operational location, e.g., configuration settings to match the target platform's hardware and software.

A browser-based graphical user interface (GUI), or other interface, provides access for administrative, configuration, report viewing, and runtime statistics in real-time. The GUI is preferably compatible with mainline browser products, e.g., Microsoft Internet Explorer 6.x and 7.x for the operating system versions Microsoft Windows XP, 2003, and Vista. At a minimum, the command-line user interface controls: a) message queue browser, b) web service status manager, c) secure log-on and password management, c) local user administration, d) LDAP user administration, e) machine user interface authentication management, f) authorization host interface configuration, g) encryption service provider configuration, h) cardholder data initialization, i) import management, j) scheduler control, k) data store maintenance, l) alert configuration, m) activity log dumping, n) runtime statistics output, o) system startup/stop/reset, p) CVQ validation rules management, q) business, technical, and functional rules management, and r) database management.

For web service based authorization host integration modes, the interface provides the current number of active web service requests, average length of time to respond over a configurable period of time for each listener, and other web service responder activity information. The GUI controls provided for Web Services access is a restricted set. A selected set of the more useful elements of the GUI controls available in a browser-delivered dashboard control is also available in XML machine readable format. this helps facilitate its integration into a customer's existing enterprise application monitoring.

A selected set of the raw data provided is used to derive the more useful reports visible in the Runtime Reports section of the GUI. An XML machine readable format can be used to better facilitate its integration into the customer's existing enterprise application monitoring.

A user administration facility provides for password management, and for adding and deleting users. At a minimum, it also provides for changing user attributes. Lightweight Directory Access Protocol (LDAP) user administration allows for centralized user and role management within the enterprise. Internal system storage of cardholder data must be compliant with the standards set forth in the latest officially released version of the Payment Card Industry Data Security Standard (PCIDSS). https://www.pcisecuritystandards.org/

QVS/QVM embodiments may allow the validation of CVQ's through a message-oriented implementation based on a Web Services model. In order to better support the integration with mainframe environments that have not adopted the techniques, technology, and interfaces associated with Web Services, the validating of CVQ's through the use of the IBM Websphere MQ (MessageQ), an many others, may be a solution. A rules-based service can be included for the creation and invocation of general purpose business rules to trigger subsequent actions. E.g., sending a notification if the last CVQ index used was within a threshold of closeness to the last possible index value. A rules engine can be used to implement validation logic to support a variable number of characters and non-contiguous groupings for VAN card-specific application. It can also be used to implement card number decoding in PANcard processing. The dynamic PAN value from a PANcard-based transaction is decoded based on customer-defined logic to return a unique identifier, such as a decoded PAN, account number, etc.

The task of decrypting obfuscated data from a QVS/QVM database can be offloaded to a vendor supplied hardware security module. The task of encrypting sensitive data during the process of writing to the QVS/QVM database can also be offloaded to vendor supplied hardware security modules.

During operation, the QVS/QVM may be enhanced by a daily update of cardholder information and activity attributes in order to implement the management of the CVQ validation window size. Such information can be imported daily in bulk from customer provided data sources. A mechanism must be provided to pass the needed information from the external data source into the QVS/QVM database so that it is available to a CVQ window validation logic. Such mechanism should support either being driven by the scheduler or on an ad-hoc basis.

In a QVM, internal log tables in the data store will fix the maximum number of rows that the table is allowed to reach. Once it reaches that limit, limit behavior is invoked. When the row count is reached for a table whose growth limit has been reached support must be provided to either allow the over-writing of old records silently, or to continue past the limit but send out email notifications or SNMP traps.

The user interface supports the manual trimming/purging of old records from growth tables. With this function an option must be provided to export the trimmed records from the system to a data file on the browser desktop. Once user authentication has occurred the web application home page provides a display area containing a virtual dashboard for displaying statistics and counters of the most important activities. The dashboard provides the real-time or very frequently updated display of several important runtime activity actions. At the very least these includes the count since last reset of the number of CVQ validation requests received, and number of those that were successfully validated, and the number there had failed validation for each of the supported reasons, and the error number. The reset function is tied to the user's login ID such that one user's reset action will not impact another user's counter values.

Given the near real-time nature of QVS/QVM and the need to keep it prioritized with its transaction authorization processing workload, the logic to implement user-based actions such as statistics viewing as well as the generation of reports and plots must have low impact on platform running QVS, e.g., through effective workload prioritization techniques on the server, and workload distribution techniques between the server and browser.

It is important provide a consistent look and feel, e.g., with product packaging and manifests, installation menus, splash screens, help systems, GUI dialogs, etc.

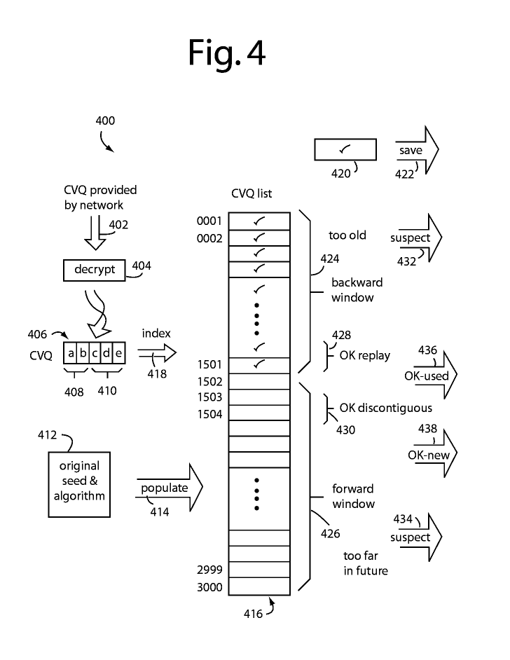

FIG. 4 represents a CVQ analysis data flow 400, in an embodiment of the present invention that is used in a card issuer's data center to help validate a CVQ 402 provided by a card association network to an issuer authorization host. The provided CVQ 402 is decrypted in a process 404 to recover an original CVQ 406. One example of which has two parts, a two-digit index 408 and a three-digit payload 410. An original key and algorithm 412 were used during personalization of the payment card to create a CVQ table of as many as 3000 CVQ values. The key may be advantageously taken from some personal information known about the user, and could include their account number, social security number, birthdates, or other data not freely published.

During on-going financial transaction operations later, the original key and algorithm 412 are used again to populate 414 a CVQ list 416. CVQ 406 can then be used to index 418 into the CVQ list 416. In FIG. 4, for convenience of this explanation, the CVQ values are placed in order in list positions 0001-3000. Any ones already used, are given a check mark, e.g., on a last CVQ value 420, and saved 422 for reference later. List positions 0001-3000 are divided into two groups, a backward window 424 and a forward window 426. Forward and backward are in reference to the last CVQ value 420 known to have been used.

Valid transactions do not necessarily have to provide the next available CVQ value, e.g., position 1502 in CVQ list 416. It can happen that a CVQ value will be replayed, e.g., positions 1500-1501 in CVQ list 416. It can also happen that CVQ values provided by the card association network will skip ahead creating discontinuities, e.g., position 1504 in CVQ list 416. For example, an OK-replay 428 event will occur when a hotel accepts a credit card and obtains an authorization without running a charge. Then the same CVQ would be used again to place the charge a few days later when the user checked out. An OK-discontinuous 430 event would occur if the payment card was used in card readers that did not result in a financial transaction, e.g., to access an ATM area or to identity oneself to an airline ticket machine.

But CVQ values that are too old will generate a suspect flag, and those expected too far in the future will receive another suspect flag 434. Transactions that are probably legitimate uses of the payment card will produce OK-used flag 436 and OK-new flag 438. All these are communicated to the card issuer authorization host to make a final determination the information from the card association network provided was valid and the transaction should be authorized.

Card behavior transaction history can be used to decide if a present transaction should be authorized. For example, if a card was used in the past month ten times daily, and now it is not being used at all, then its forward and backward window sizes may need to be adjusted. Merchant and transaction types can also be included in a card behavior transaction history. If the merchant type is hotel, airline boarding, etc., they can be expected to initially swipe the card when the customer checks in, and then actually run the charges only once a week.

Customer-authorized recurring charges can trigger too-far-forward (TFF), OK forward (OKF), OK replay (OKR), USED, OK backward (OKB), and INVALID responses.

Dynamic rule sets and parameters can be changed according to card usage history, e.g., as provided in the usage statistics output by data-warehouse 137 (FIG. 1).

Table-I is a computer programming pseudocode for one exemplary Rule Set in which TFF, OKF, OKR, USED, OKB, and INVALID, are defined in software. Other rule sets are possible and may be preferable in particular applications.

TABLE I
RULE SET

| where, Δt: | t _{new} − t ₗₐₛₜ |
|---|---|
| σ: | standard deviation |
| A, B, C, D, E: variables | |
| MCC: | merchant category code |

| | |
|---|---|
| TFF: if | Δt ≧ ( Avg (Δt) + Aσ ) |
| | and idx _{cur} > idx ₗₐₛₜ |
| | and idx _{cur} not used |
| | and Δt > 0 |
| OKF: if | 0 ≦ Δt < ( Avg (Δt) + Bσ ) |
| | and idx _{cur} > idx ₗₐₛₜ |
| | and idx _{cur} not used |
| | and Δt > 0 |
| OKR: if | Δt ≦ C |
| | and idx _{cur} ≦ idx ₗₐₛₜ |
| | and idx _{cur} used |
| | and MCC in approved list (e.g., hotel) |
| | and Δt > 0 |
| USED: if | Δt > D |
| | and idx _{cur} ≦ idx ₗₐₛₜ |
| | and idx _{cur} used |
| | and Δt > 0 |
| OKB: if | 0 ≦ \|Δt\| < ( Avg (Δt) + Eσ ) |
| | and idx _{cur} < idx ₗₐₛₜ |
| | and idx _{cur} not used |
| | and Δt < 0 |
| INVALID: | if idx _{cur} > idx ₘₐₓ |
| | or idx _{cur} < idx ₘᵢₙ |

Although particular embodiments of the present invention have been described and illustrated, such are not intended to limit the invention. Modifications and changes will no doubt become apparent to those skilled in the art, and it was intended that the invention only be limited by the scope of the appended claims.

The invention is claimed, as follows.

1. A method for validating payment card transactions, comprising:
beginning by, eliciting a card verification value from a payment card contemporaneously involved in a financial transaction, wherein such card verification value is one of many that were electronically preprogrammed into such payment card when it was earlier personalized and issued to a user;
then at a card issuer data center, regenerating an array of card verification values from a key and an encryption algorithm that were used originally to personalize the particular said payment card;
then, comparing said card verification value obtained in the step of eliciting to individual card verification values included in said array obtained in the step of regenerating; and
then, validating said financial transaction based on the results obtained in the step of comparing.

2. The method of claim 1, further comprising:
expecting card verification values elicited from particular payment cards to follow an order of use, wherein certain card verification values can be expected to be used soon and others can be expected not to be used for some time if fraud is not a factor.

3. The method of claim 2, further comprising:
keeping a running account of which card verification values elicited from particular payment cards have been used and when, so as to enable a prediction of which card verification values can be expected to be used soon and others can be expected not to be used for some time if fraud is not a factor.

4. The method of claim 1, further comprising:
an application database that identifies the keys and encryption algorithms originally used to electronically program said payment card when it was personalized and issued to said user; and
providing an archive of such information as needed in real-time later to validate financial transactions that seem to originate from said payment card.

5. A computer program for validating payment card transactions, comprising:
a first process for eliciting a card verification value from a payment card contemporaneously involved in a financial transaction, wherein such card verification value is one of many that were electronically programmed into such payment card when it was earlier personalized and issued to a user;
a second process for regenerating an array of card verification values from an identifier for that encryption algorithms that were used originally to personalize the particular said payment card;
a third process for comparing said card verification value obtained in the step of eliciting to individual card verification values included in said array obtained in the step of regenerating; and
a fourth process for validating said financial transaction based on the results obtained in the step of comparing.

6. The computer program of claim 5, further comprising:
another process for expecting card verification values elicited from particular payment cards to follow an order of use, wherein certain card verification values can be expected to be used soon and others can be expected not to be used for some time if fraud is not a factor.

7. The computer program of claim 5, further comprising:
a further process for keeping a running account of which card verification values elicited from particular payment cards have been used and when, so as to enable a prediction of which card verification values can be expected to be used soon and others can be expected not to be used for some time if fraud is not a factor.

8. The computer program of claim 5, further comprising:
a fifth process for application database storage of information that identifies the keys and encryption algorithms originally used to electronically program said payment card when it was personalized and issued to said user; and
a sixth process for providing an archive of such information as needed in real-time later to validate financial transactions that seem to originate from said payment card.

9. A computer network appliance for validating payment card transactions, comprising:
a computer hardware platform for hosting and executing financial transaction validations for a host mainframe in a card issuer's data center;
a computer program executed by the computer hardware platform and providing for eliciting a card verification value from a payment card contemporaneously involved in a financial transaction, wherein such card verification value is one of many that were electronically programmed into such payment card when it was earlier personalized and issued to a user;
a computer program executed by the computer hardware platform and providing for regenerating an array of card verification values from an identifier for the encryption algorithms that were used originally to personalize the particular said payment card;
a computer program executed by the computer hardware platform and providing for comparing said card verification value obtained in the step of eliciting to individual card verification values included in said array obtained by the computer program for regenerating;
a computer program executed by the computer hardware platform and providing for validating said financial transaction based on the results obtained by the computer program for comparing;
a computer program executed by the computer hardware platform and providing for expecting card verification values elicited from particular payment cards to follow an order of use, wherein certain card verification values can be expected to be used soon and others can be expected not to be used for some time if fraud is not a factor;
a computer program executed by the computer hardware platform and providing for keeping a running account of which card verification values elicited from particular payment cards have been used and when, so as to enable a prediction of which card verification values can be expected to be used soon and others can be expected not to be used for some time if fraud is not a factor;
a computer program executed by the computer hardware platform and providing for data warehousing information that identifies the keys and encryption algorithms originally used to electronically program said payment card when it was personalized and issued to said user; and
a computer program executed by the computer hardware platform and providing for an archive of such information as needed in real-time later to validate financial transactions that seem to originate from said payment card.
